(19) United States
(12) Patent Application Publication
(10) Pub. No.: US 2026/0146703 A1
(43) Pub. Date: May 28, 2026

(54) ADJUSTABLE STAND AND SUPPORT ASSEMBLY

(71) Applicants: Jaren Faleide, Denver, CO (US); Ronald Faleide, Denver, CO (US)

(72) Inventors: Jaren Faleide, Denver, CO (US); Ronald Faleide, Denver, CO (US)

(21) Appl. No.: 19/397,450

(22) Filed: Nov. 21, 2025

Related U.S. Application Data
(60) Provisional application No. 63/725,407, filed on Nov. 26, 2024.

(51) Int. Cl. F16M 11/20; F16M 11/22

(52) U.S. Cl. CPC F16M 11/2014; F16M 11/22

(57) ABSTRACT

A stand assembly to support a press for extracting juice or pressing other items. The stand assembly comprises a support assembly with a wheel assembly disposed on an underside thereof. The support assembly comprises groups of individual links. Each group of links comprises at least a top link disposed above a bottom link in a spaced apart relation to one another. An individual vertical support is disposed between the top and bottom link of a group at a distal end thereof. The position of the individual vertical supports is adjustable along the length of the links. A common vertical support is disposed between individual links at a proximal end thereof at an intersection point of the links of different groups. In some embodiments, different groups of links are pivotally movable to one another to adjust the support assembly according to the geometry of the press.

This U.S. Non-Provisional Patent Application claims the benefit of priority from U.S. Provisional Patent Application Ser. No. 63/725,407, filed Nov. 26, 2024, the entire disclosure of which is hereby incorporated by reference.

### FIELD

Embodiments of the present disclosure relate to a support assembly configured to accommodate various objects including, for example, various presses for squeezing juice or for pressing other items.

### BACKGROUND

Wine making is a longstanding craft that initially requires pressing fruit to extract its juice. Such fruit may include grapes as well as other types of fruit, which may be used to produce not only wine, but also other types of products such as cider, cherry liqueur, triple sec, limoncello, etc. Wine making and producing other types of liquor generally requires an efficient pressing of the underlying fruit or produce to successfully extract its juice. In addition, it is also important that the equipment used to extract the juice be properly maintained and cleaned to avoid contamination or its own deterioration. Furthermore, pressing fruit and/or produce generally requires an efficient collection of the juice. Adding to the foregoing constraints, presses may be provided in various sizes, often making it difficult to transport them from one location to another.

Given the foregoing challenges, the relevant industry would benefit from a stand assembly that could be adjusted to support presses of different sizes and/or geometries. A further benefit would be realized by providing an adjustable stand that can support various types of presses, not only for fruit, but also for other items such as vegetables, animals, or for mechanical or industrial applications. A benefit would be realized by providing a stand assembly that could be moved with a press disposed or connected above it. The industry would also benefit if such a stand assembly were provided with a plurality of wheels that would allow a user to easily move the press between various locations, for example, a location dedicated to pressing, a location dedicated for servicing or cleaning, and/or a storage location.

### SUMMARY

Embodiments of the present disclosure are directed to stand assemblies that are operable to support a variety of presses for fruit, vegetables, food, mechanical or industrial applications and other applications. The stand assembly according to at least one embodiment of the present disclosure generally comprises a support assembly and a wheel assembly disposed underneath. The support assembly generally comprises groups of individual links that are disposed in spaced apart relation to one another in the vertical direction. The groups of links generally comprise pairs of links, i.e., a top link disposed directly above a bottom link in a spaced apart relation. However, in other embodiments any given group of links comprises more than two interconnected individual links. Each of the links of a group generally comprises a substantially equivalent shape, including length and/or width.

The support assembly further comprises individual vertical supports disposed between corresponding top and bottom links of a group. The individual vertical supports are generally disposed at distal end thereof, but their specific location along the length of the links may be adjusted, which results in a corresponding adjustment to the effective length of the links. The support assembly also comprises a common vertical support disposed between corresponding top and bottom links at fixed position around a proximal end thereof. The individual vertical supports and/or the common vertical support may comprise a sleeve or another structure that can create a vertical separation between the top and bottom link.

Individual top links and individual bottom links of different groups generally intersect around their proximal end at an intersection point. The intersection point defines an axis of rotation of the different groups of links. As such, a user may pivotally move individual groups of links with respect to one another around the intersection axis to adjust the geometry of the support assembly. It is contemplated that all the links of a group will move together as the user adjusts them. However, once a user has finished adjusting the geometry of the support assembly, e.g., so that it substantially corresponds to the geometry of the press and/or legs of an object to be associated with the support assembly, the user may lock the support assembly into position such that further movements and/or adjustments of individual groups of links is substantially prevented. In at least one alternative embodiment, one or more links are provided wherein each one of the links comprises two sections that define a “V-shape”. In such alternative embodiments, the two sections of the links are non-movable relative to one another, but can be produced to define an intended angle between them according to a specific geometry of the legs of the press.

The wheel assembly generally comprises a plurality of wheels interconnected to the underside of the support assembly. For example, in at least one embodiment the plurality of wheels comprises caster wheels, rotatable wheels, or other related wheel assembly, e.g., with a support or bracket that retains the wheels and connects them to the underside of the support assembly. However, this is not necessarily limiting as the plurality of wheels may comprise other types of wheels that can be interconnected to the support assembly via other mechanisms. Embodiments of the present disclosure contemplate that each one of the plurality of wheels may be interconnected to the underside of a bottom link below either a corresponding vertical support or below a common vertical support. However, this is not strictly limiting given that in other embodiments individual ones of the plurality of wheels are disposed on the support assembly at other locations. Furthermore, the present invention contemplates that individual legs of the press will be connected to the support assembly, for example, above top link of any given group, including above the individual and common vertical supports. As such, the individual vertical support and/or the common vertical support, the top link and the bottom link of a group, and/or a corresponding wheel(s) of the wheel assembly collectively define a corresponding segment of the support assembly.

Various concepts disclosed herein may be provided in combination with one another even if such combination is not specifically depicted or described.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, explain the principles of the disclosure.

FIG. 1 is a front perspective view of one embodiment of a press stand assembly according to the present disclosure showing a press with three legs connected to the support assembly.

FIG. 2 is a front perspective view of another embodiment of a press stand assembly according to the present disclosure with a press with three legs connected to the support assembly and an adjacently disposed container.

FIG. 3 is a front perspective view of yet another embodiment of a press stand assembly according to the present disclosure with a press with three legs connected to the support assembly.

FIG. 4 is a perspective view of one embodiment of a press stand assembly according to the present disclosure wherein its individual links have an effective length that is approximately equivalent to actual length.

FIG. 5 is a perspective view of one embodiment of a press stand assembly according to the present disclosure wherein its individual links have an effective length that is less than their actual length.

FIG. 6 is a top view of one embodiment of a press stand assembly according to the present disclosure.

FIG. 7 is a side view of one embodiment of a press stand assembly according to the present disclosure.

FIG. 8 is a front view of one embodiment of a press stand assembly according to the present disclosure.

FIG. 9 is a top view of another embodiment of a press stand assembly according to the present disclosure.

FIG. 10 is a top view of yet another embodiment of a press stand assembly according to the present disclosure.

FIG. 11 is a perspective view of one embodiment of a press stand assembly according to the present disclosure wherein its individual links have an effective length that is approximately equivalent to actual length.

FIG. 12 is a perspective view of one embodiment of a press stand assembly according to the present disclosure.

FIG. 13 is a perspective view of one embodiment of a press stand assembly according to the present disclosure showing a press with three legs 120 connected to the support assembly.

FIG. 14 is a front perspective view of another embodiment of a press stand assembly according to the present disclosure with a press connected to the support assembly.

FIG. 15 is a perspective view of yet another embodiment of a press stand assembly according to the present disclosure.

FIG. 16 is a perspective view of yet another embodiment of a press stand assembly according to the present disclosure.

FIG. 17 is a perspective view of a further embodiment of a press stand assembly according to the present disclosure.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION

Reference to an element by the indefinite article “a” or “an” does not exclude the possibility that more than one element is present, unless the context clearly requires that there be one and only one element. The indefinite article “a” or “an” thus usually means “at least one.”

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the system under study, and can be readily appreciated by one of skill in the art.

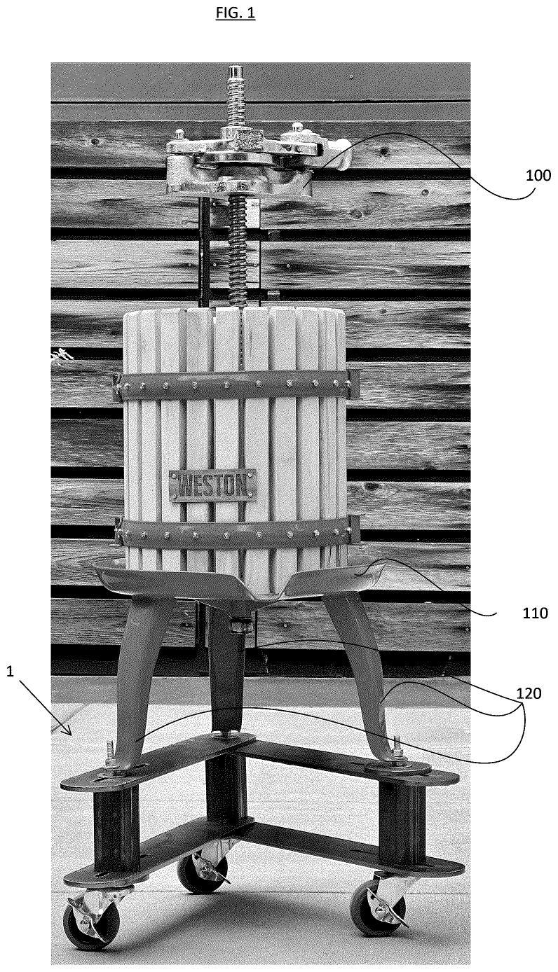

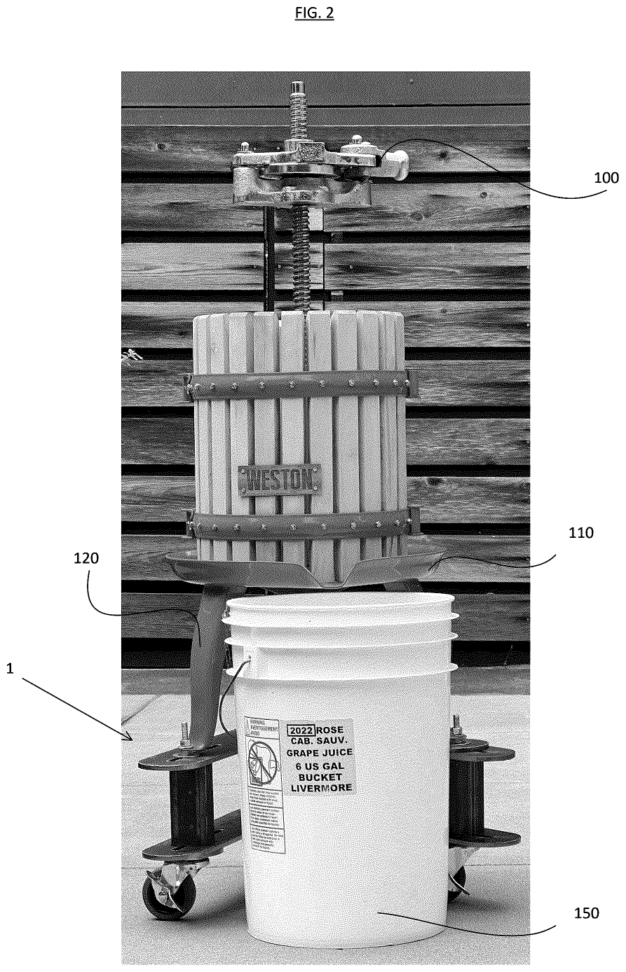

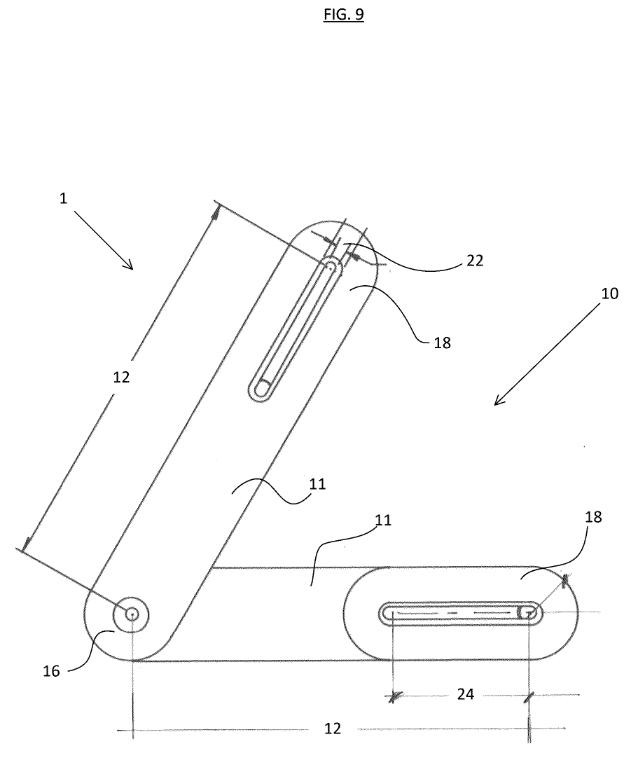

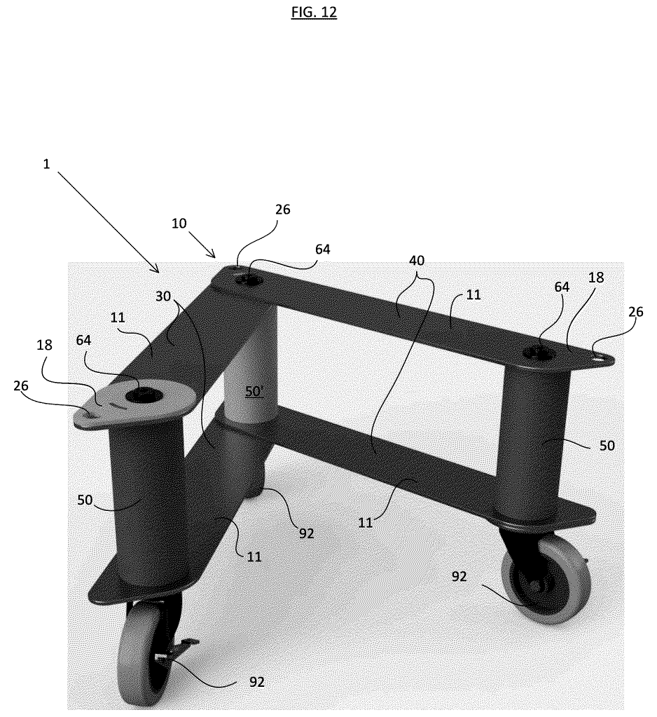

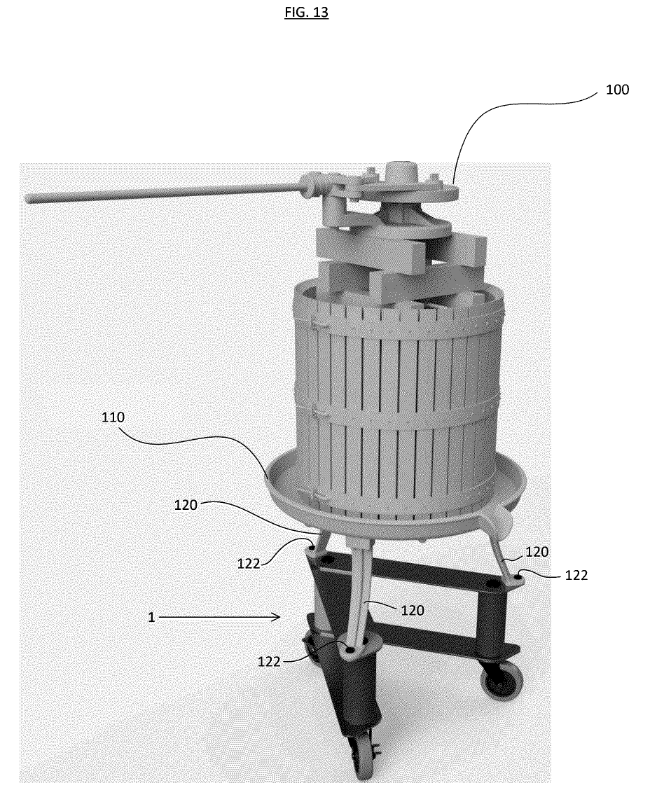

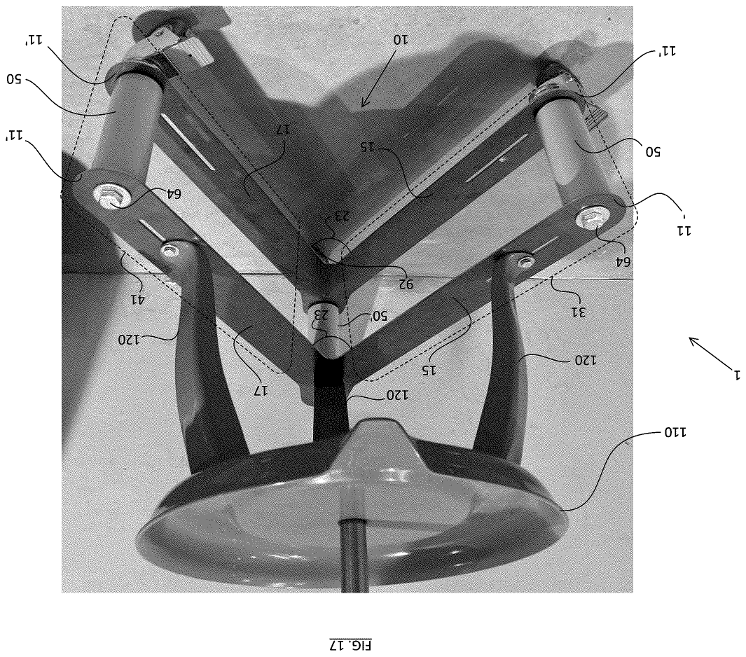

With initial reference to FIGS. 1-17, embodiments of the present disclosure are directed to a stand assembly 1 for a press 100 or other items to be supported and/or moved on the stand or support assembly. Such other items include, without limitation easels, water coolers, ice coolers, computers, printers, faxes, wood blocks for sculpting, vehicle engines, decorative vases, coffee roasters, garbage bins, pallets, etc. As used herein a “press” refers to various types of presses for pressing, squeezing and/or collecting fruit juice, e.g., grape juice, apple juice, berry juice, etc., including to produce distilled liquors such as wine, cider, etc. As contemplated by various embodiments, a press 100 comprises a collection structure 110 and a plurality of legs 120 that may be connected to a stand assembly 1 via one or more connectors 122. However, as is also used herein, a “press” may also refer to another type of press for pressing or squeezing other items such as vegetables to collect their juice, oil, or extract, or animals to collect their blood, for example via a separate container 150 that may be disposed proximate to the collection structure 110. A “press” may further refer to a press used for mechanical and/or industrial applications, for example, for pressing raw or processed materials. As such, the stand assembly 1 according to various embodiments of the present disclosure contemplates being able to provide support to a plurality of legs 120 or segments of the press 100 or other equipment around at least three distinct connection points, which may collectively define various geometries and/or shapes thereof. Accordingly, the inventive support assembly 10 is intended to have an adjustable geometry, including according to the location of the legs 120 or support segments of the press 100. In some embodiments, and as will be explained in more detail hereinafter, the inventive stand assembly 1 is also movable.

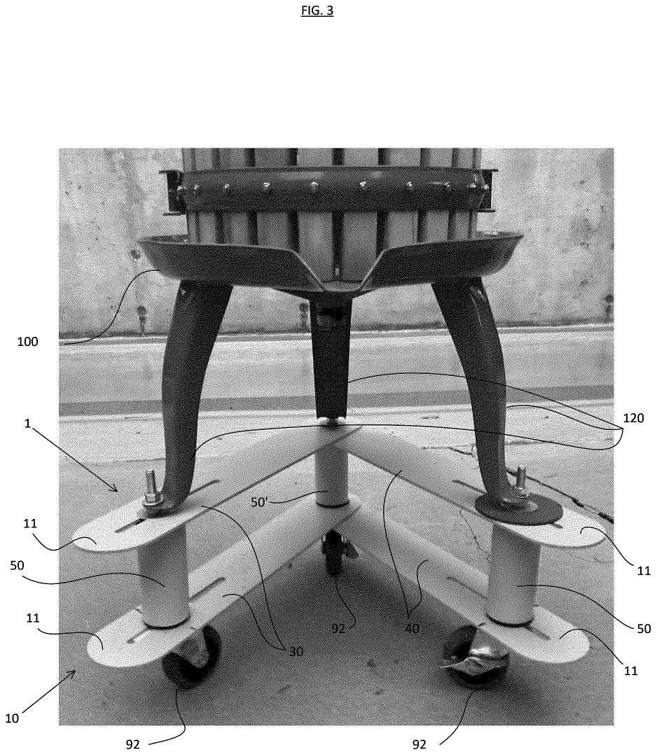

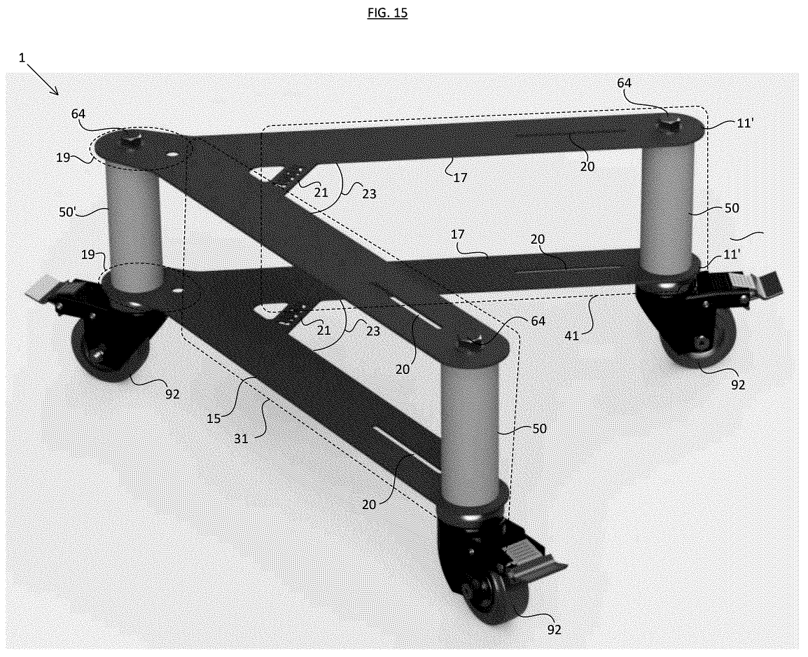

As is perhaps best shown in the illustrative embodiments of FIGS. 3-5, some embodiments of the stand assembly 1 comprise a support assembly 10 with at least two groups of links 11 that collectively define a shape comprising at least three leg stand points, which as will be explained hereinafter are generally above individual vertical supports 50 and a common vertical support 50′. In at least one alternative embodiment, and as shown in FIGS. 15-17, the stand assembly 1 comprises a support assembly 10 with one group of links 11′, i.e., a pair of links 11, that also define a shape comprising at least three leg sand points. As used herein, a group 30 and/or 40 of links generally refers to at least a pair of individual links 11 interconnected to one another, and which move together as an ensemble. However, another alternative embodiment according to the present disclosure contemplates that a group 30 and/or 40 of links comprise a single link 11. As shown in FIGS. 15-17, in some embodiments the stand assembly 1 comprises one group 31 of links 11 comprising a “V-shape” and collectively defining at least three leg stand points. In other alternative embodiments, a single link 11 of a group 30 and/or 40 comprises a cross-section, e.g., a rectilinear cross-section, that is operable to support or at least partially support the equipment or component disposed above without an additional interconnected link(s) 11.

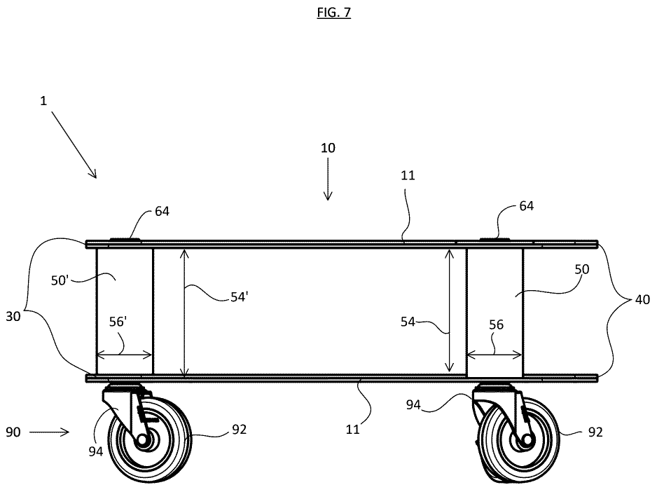

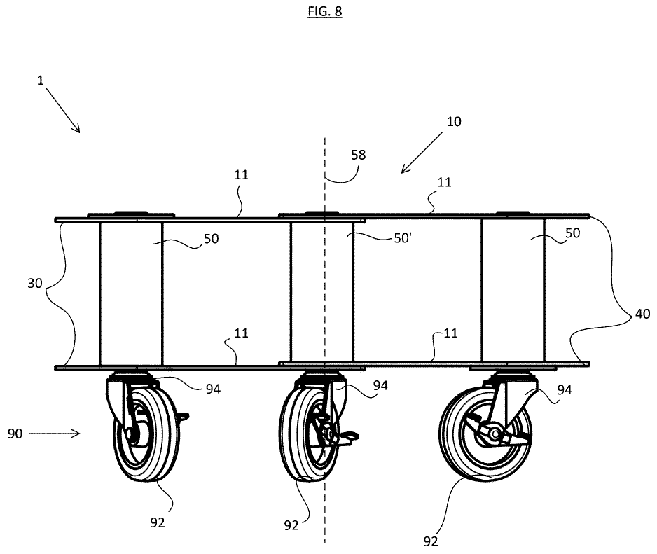

As shown throughout FIGS. 1-14, two groups 30 and 40 of links 11 are shown as being connected to one another through overlapping links 11. However, other embodiments contemplate that more than two groups of links 11 may be provided according to the need and/or the specific number of legs 120 of the press 100 or other equipment that require support. Thus, in one or more embodiments, including those represented in FIGS. 1-14, each of the two groups 30 and 40 comprises at least two individual links 11 interconnected to one another. As is perhaps best shown in FIGS. 7-8, in various embodiments, individual vertical supports 50 are disposed proximate to the distal end 18 of the links 11 and a common vertical support 50′ is disposed adjacent to a proximal end 16 of the links. The individual vertical supports 50 and common vertical supports 50′ generally comprise equivalent shape, for example, with a substantially equivalent height 54 and 54′, and/or a substantially equivalent width or diameter 56 and 56′. The illustrative embodiments of FIGS. 1-8 show individual vertical supports 50 and a common vertical support 50′ comprising a substantially cylindrical shape with a substantially circular cross-section. However, this is not necessarily limiting, as other shapes of the individual vertical supports 50 and/or common vertical support 50′ are also contemplated. For example, in some embodiments the individual vertical supports 50 and or common vertical supports 50′ comprise a cross-section that is substantially square, rectangular, triangular, elliptical, ovoidal, polygonal, etc.

With reference again to at least FIGS. 7-8, each group 30 and/or 40 of links 11 generally comprises a pair of individual links 11, i.e., a bottom link 11 and a top link 11 disposed in a spaced apart relation to one another. As shown in FIGS. 15-17, in some alternative embodiments a pair of links 11′ comprising a V-shape is provided with a top link 11′ being disposed in a spaced apart relation to a bottom link 11′. In at least another alternative embodiment as discussed above, a group 30 and/or 40 comprises a single link 11. However, it is possible for the groups 30 and/or 40 of links 11 to comprise more than two links 11 disposed in a spaced apart relation to one another. For example, in some embodiments a top link 11 is disposed above a middle link 11, which itself is disposed above a bottom link 11. Generally, the distance of separation between top and bottom links 11 of a group 30 and/or 40 is substantially equivalent to the height 54 and/or 54′ respectively of the individual vertical supports 50 and/or 50′.

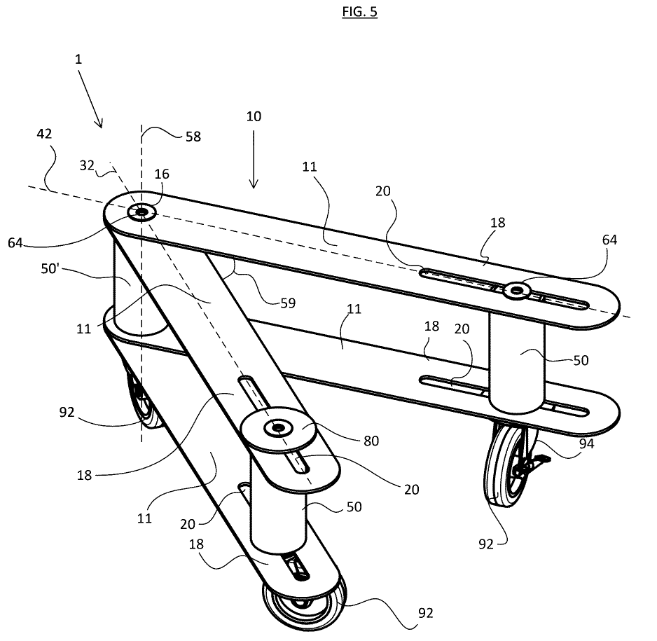

In the embodiments represented in at least FIGS. 1-5 and 7-8, there is one common vertical support 50′, which is shared by groups 30 and 40. In at least one alternative embodiments, a top link 11 and a bottom link 11 are not disposed in a spaced apart relation to one another, but are adjacently disposed to one another, i.e., in direct confronting relation. As is also shown in the illustrative embodiments of at least FIGS. 1-5 and 7-8, in some embodiments the stand assembly 1 comprises one individual vertical support 50 for each of the two groups 30 and 40 of links 11. As such, the first and second groups 30 and 40 of links 11 are connected to one another about an axis 58 defined at the intersection point of corresponding pairs of links 11 of each group 30 and/or 40. Furthermore, one or more embodiments of the stand assembly 1 according to the present disclosure contemplate that each of the two groups 30 and 40 of links 11 be connected and pivotally movable to one another about axis 58, which is substantially coincident with an intersection point thereof. As is shown at least in FIG. 5, in some embodiments of the stand assembly 1, the axis 58 is also substantially coincident to the approximate center of the cross-section of the common vertical support 50′.

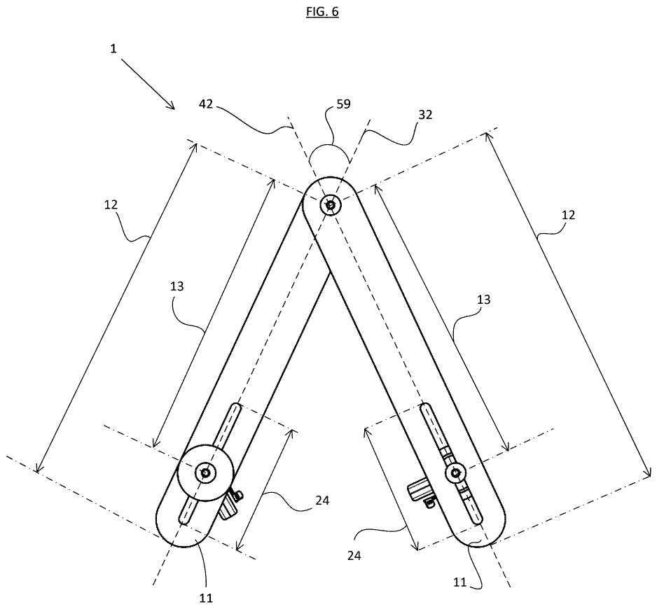

With reference to at least the illustrative embodiment of FIG. 6, and as briefly mentioned above, in one or more embodiments of the stand assembly 1, the geometry of the support assembly 10 is adjustable. As is shown at least in FIGS. 15-17, in other embodiments, the geometry of the support assembly 10 is not adjustable, but the individual links 11 may comprise an intended geometry according to the specific need. While it is contemplated that the individual links 11 of all or some of the groups comprise a substantially equivalent length 12, this is not strictly necessary as some embodiments of the stand assembly 1 contemplate that the length 12 of the links 11, 11′ of a given group may be different than the length 12 of the links 11, 11′ of another group(s). Furthermore, some embodiments of the stand assembly 1 according to the present disclosure contemplate that all the links 11, 11′ within a group also have a substantially equivalent effective length 13. As used herein, an “effective length” of the links 11, 11′ refers to a distance away from the intersection point where a leg 120 of the press 100 may be disposed or otherwise supported. As also used herein, an “effective length” of the links 11, 11′ may also refer to the separation, along the length of the links 11, 11′ of a group, between the intersection point and the approximate center of a corresponding individual vertical support 50. Accordingly, a user may increase or decrease the effective length 13 of individual links 11, 11′ within a group according to the specific need. Furthermore, some embodiments of the stand assembly 1 according to the present disclosure contemplate that the effective length 13 of all links 11, 11′ within a group be substantially equivalent, including to achieve and/or maintain stability.

As is shown at least in the illustrative embodiments of FIGS. 6 and 9-10, the links 11, 11′ generally comprise an overall length 12 that is measured from the intersection point, i.e., around the proximal end 16, to an edge of the link around distal end 18. As is also shown at least in the illustrative embodiment of FIG. 5, a slot 20 is generally disposed on the links 11, 11′, which generally comprises a length 24 and/or a width. The slots 20 are generally disposed along an axis 32 and/or 42 defined along the length 12 of individual links 11, 11. The slot 20 may be used to retain a connector 64, such as a screw, bolt, etc., that may be used to interconnect corresponding links 11 of a group 30 and/or 40. The length 24 of the slot 20 is intended to provide the user a plurality of positions wherein to place and/or secure an individual vertical support 50 around the distal end 18 of the links 11, 11′ of a group. Said differently, a user may increase or decrease an effectively length 13 of the links 11, 11′ by adjusting the position of an individual vertical support 50 along the length 24 of the slot 20.

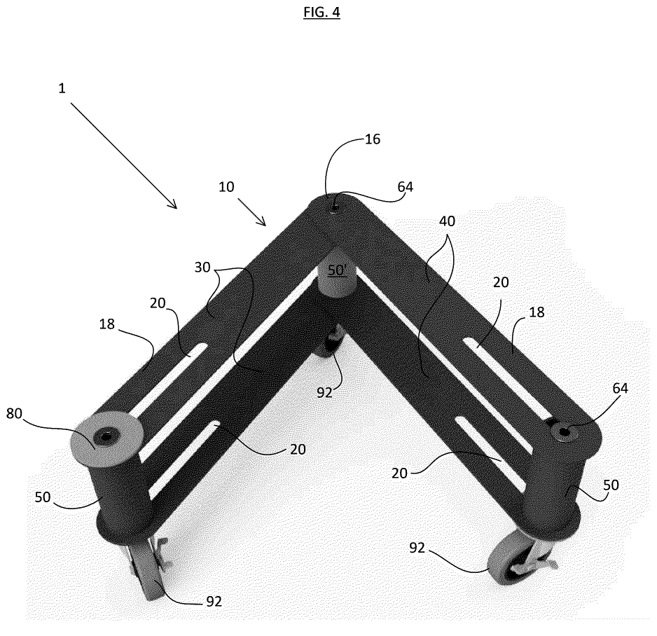

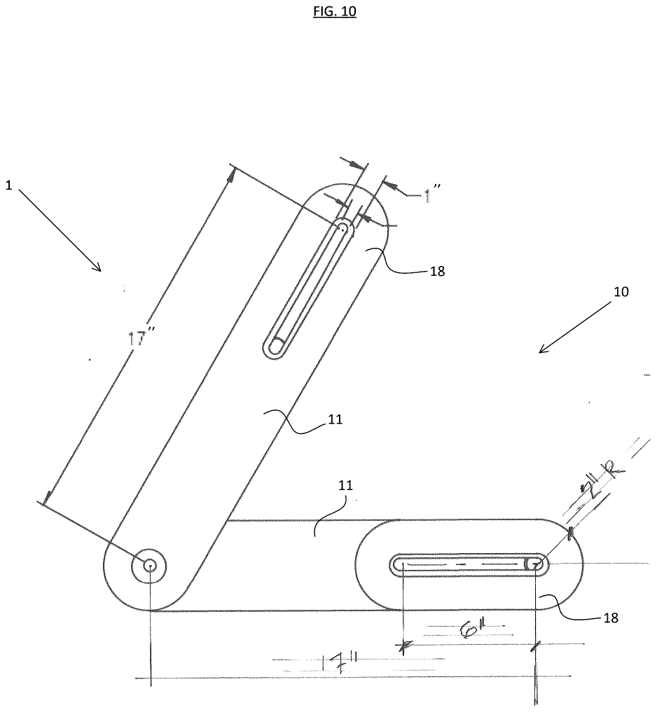

A is shown in the illustrative embodiment of FIG. 6, the links 11, 11′ comprise a substantially equivalent length that is smaller than their overall length 12. However, the effective length 13 of a link 11, 11′, measured from the intersection point or opening thereof, may be substantially equivalent to the actual length 12 of the same link 11, 11′ if the user places the individual vertical supports 50 at a position along the length 24 of the slot 20 that is the furthest away from the proximal end 16, e.g., as shown in the illustrative embodiment of FIG. 4. By way of example only, the illustrative embodiment represented in FIG. 10 comprises links 11 with an overall length 12 of about 17 inches and with a slot 20 length 24 of about 6 inches, which allows a user to adjust the effective length 13 of each link 11 to be about 11 inches to about 17 inches. In the illustrative embodiment of FIG. 10, the links 11 comprise a width of approximately less than 1 inch and a round portion of the proximal end 18 with a radius of about 2 inches.

In some embodiments, as is shown at least in FIGS. 1-5, each of the groups 30 and/or 40 are intended to at least partially define a first and/or a second segment of the support assembly 10 that pivotally moves as a unit with respect to one another about axis 58 or the intersection point thereof. With reference to at least the illustrative embodiment of FIG. 6, once a desired position or desired angle 59 is achieved, the user may then lock or otherwise secure the support assembly 10 into place such that the groups 30 and/or 40 of links 11 can no longer pivotally move, and such that the position of the individual vertical supports 50 along the length 24 of the slot 20 can no longer be adjusted. However, as shown in FIGS. 15-17, the foregoing embodiments are not strictly limiting as in other embodiments of the stand assembly 1, individual links 11′ comprise two sections 15 and 17, which define a first segment 31 and/or second segment 41 of the support assembly 10. In at least one alternative embodiment, the two sections 15 and 17 of the link(s) 11′ are non-movable.

As is shown in the illustrative embodiments of FIGS. 1-5 and 7-8, the press stand assembly 1 according to the present invention may further comprise a plurality of wheels 92 disposed on an underside of the links 11, 11′. For example, as is shown in the illustrative embodiments of FIGS. 7-8, individual wheels 92 are generally interconnected to the plurality of links 11, 11′ on an underside thereof via an interconnecting mechanism 94. In one embodiment, the stand assembly 1 comprises caster wheels operatively disposed on a bracket that interconnects them to the underside of the support assembly 10. Accordingly, in one or more embodiments, individual wheels 92 are disposed below individual vertical supports 50 and/or the common vertical support 50′. As such, the effective length 13 of the links 11, 11′ may also correspond to the position of the individual wheels 92 disposed below the vertical supports 50.

Furthermore, a single individual connector 64 may securely retain a top link 11 and/or 11′, a vertical support 50 and/or 50′, a bottom link 11 and/or 11′, and/or a corresponding interconnecting mechanism 94 and or wheel 92. In addition, and as shown at least in the illustrative embodiments of at least FIGS. 3-6, a washer 80 and/or other attendant hardware may be disposed above a top link 11, for example, to securely retain groups or pairs of links 11 and/or to secure at least a portion of a corresponding leg 120 of the press 100. However, the foregoing is not necessarily limiting as various embodiments of the stand assembly 1 according to the present disclosure contemplate incorporating other fastening or retaining mechanisms for the support assembly 10, individual links 11, 11′ vertical support 50 and/or 50′, or brackets 94 of the wheel assembly 90. For example, the connectors 64 may comprise a corresponding knobs or caps that a user may rotate to reduce an effective height of the connectors 64 thereby loosening the links 11, 11′ and/or corresponding vertical support 50 or 50′ and/or wheel assembly 90 to adjust the effective length 13 of the links 11, 11′. Other mechanism to efficiently loosen the links 11, 11′ vertical support 50 or 50′ and wheel assembly 90 include levels, quick releases, latches, clamps, pins, knots and the like.

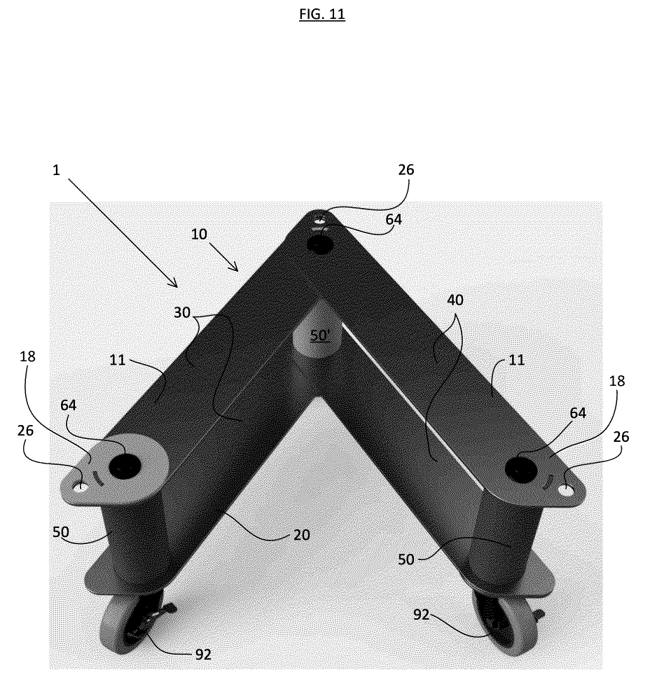

FIGS. 11-14 show alternative embodiments of the press stand assembly 1 according to the present disclosure. In these alternative embodiments, the press stand assembly 1 comprises groups 30 and/or 40 of individual links 11 without a slot 20, but with an opening 26 disposed on the top link 11 of a group. In embodiments, including those represented in FIGS. 11-14, the aperture 26 is configured and dimensioned to receive a connector, for example, to connect the legs 120 of a press stand. Accordingly, in such alternative embodiments, the groups 30 and/or 40 of links 11 may be pivotally adjusted according to the geometry of the stand or other equipment being supported.

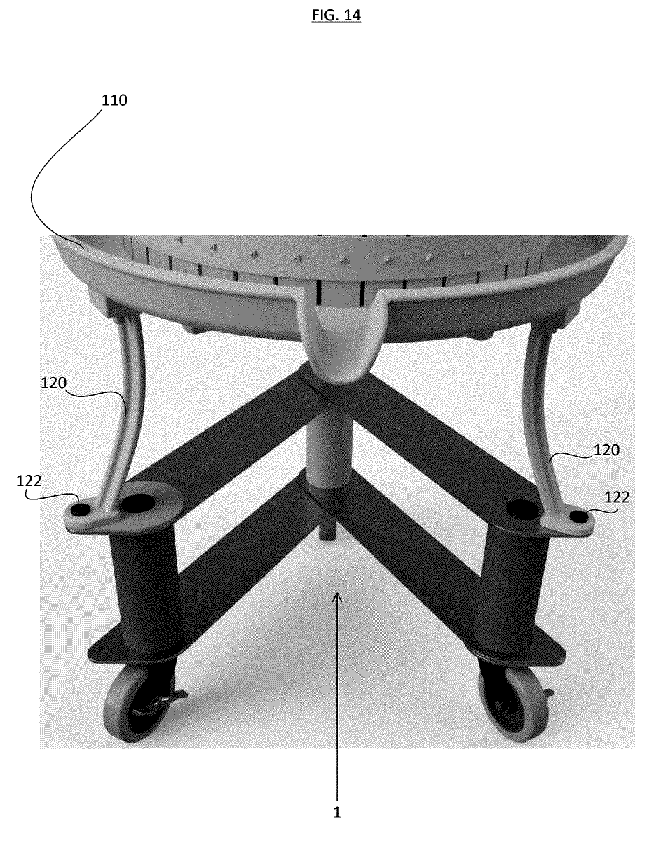

With reference to FIGS. 14-17 and as mentioned above, some embodiments of the stand assembly 1 according to the present disclosure contemplate providing a support assembly 10 with links 11′ comprising an alternative shape. In one or more embodiments, the stand assembly 1 comprises a support assembly 10 comprising two (or more) interconnected links 11′ comprising a “V-shape”. For example, in one or more embodiments, a pair of links 11′ are provided, each one comprising a first section 15 connected to a second section 17. As shown in FIGS. 15-17, in some embodiments the first sections 15 of a pair of links 11′ define a first segment 31 of the support assembly 10. As is also shown in FIGS. 15-17, in some embodiments the second sections 17 of the same pair of links 11′ defines a second segment 41 of the support assembly. In such alternative embodiments, the sections 15 and 17 as well as the segments 31 and 41 are fixed to one another at an intersection area 19.

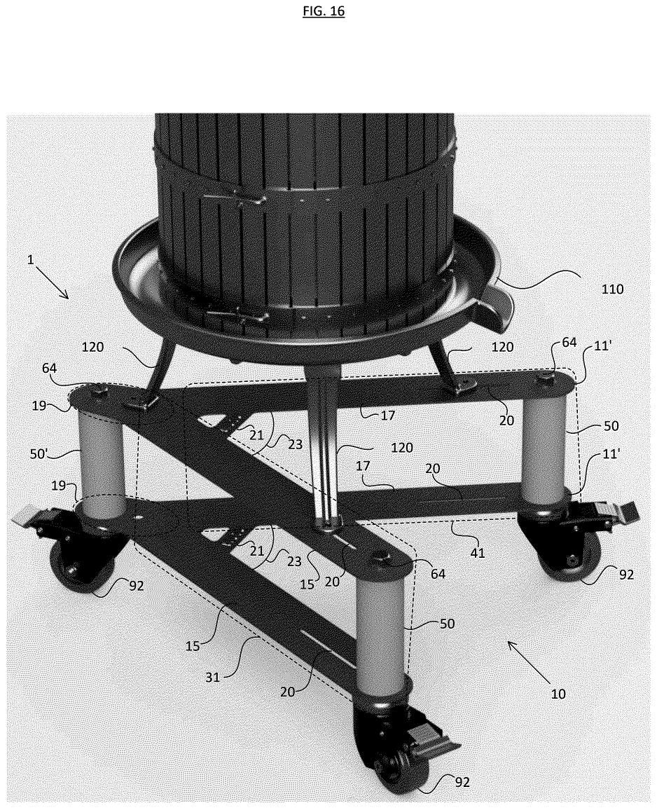

Also with reference to FIGS. 15-17, in one or more embodiments, the sections 15 and 17 of a link 11′ define an interior angle 23 that can be set according to an intended geometry or position of the legs 120 or supports of a press 100 and/or other equipment. Such alternative embodiments, also contemplate that the individual sections 15, 17 of the links 11′ be provided with a slot 20 as described herein. As such, a press or equipment leg 120 may be selectively fixed along the length of the slot 20 to accommodate a press(es) 100 or equipment of different dimensions. In addition, as depicted in FIGS. 15-17, in some embodiments a locking structure is operatively connected to the wheels 92 to selectively lock them in a desired position. As is also represented in FIGS. 15-17, in some embodiments of the stand assembly 1 comprising “V-shaped” links 11′, individual vertical supports 50 are provided between spaced apart links 11′ around a distal end respectively of the first section 15 and the second section 17 of the links 11′. As is further shown in FIGS. 15-17, in one or more embodiments, a common vertical support 50′ is provided between spaced apart links 11′ around a common proximal end of the sections 15 and 17. As is shown in the FIGS. 15-16, in some embodiments a brace 21 is provided between the first section 15 and second section 17 of a link 11′, for example, to enhance stability.

Thus, the examples set forth above are provided to give those of ordinary skill in the art a complete disclosure and description of how to make and use the embodiments of the disclosure and are not intended to limit the scope of what the inventors regard as the scope of the disclosure. Modifications of the above-described modes for carrying out the disclosure can be used by persons of skill in the art, and are intended to be within the scope of the following claims.

It is to be understood that the disclosure is not limited to particular embodiments, which can, of course, vary. It is also to be understood that the terminology used herein is for the purpose of describing particular embodiments only, and is not intended to be limiting.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A stand assembly for a press, the stand assembly comprising:
a support assembly comprising a plurality of individual links each one comprising a substantially equivalent length and a substantially equivalent width;
a first group of individual links of the plurality, a first vertical support and a common vertical support collectively defining a first segment of the support assembly;
a second group of individual links of the plurality, a second vertical support and the common vertical support collectively defining a second segment of the support assembly;
a distal end of the first segment and a distal end of the second segment connected to one another at an intersection point thereof;
each of the first segment and the second segment comprising an effective length that is adjustable,
the first segment and the second segment pivotally movable to one another about an axis defined at the intersection point thereof, and
a wheel assembly comprising at least three wheels disposed below the support assembly.

2. The stand assembly as recited in claim 1, wherein each one of the plurality of links comprises an elongated shape and a slot disposed on a distal end thereof; and wherein the slot comprises a length that is less than the length of a corresponding link of the plurality.

3. The stand assembly as recited in claim 1, wherein the each of the first group and second group of individual links comprises a top link disposed above a bottom link in spaced apart relation to one another.

4. The stand assembly as recited in claim 3, wherein each of the first vertical support, the second vertical support and the common vertical support comprise a substantially equivalent height that defines a distance of separation between the top link and the bottom link.

5. The stand assembly as recited in claim 3, wherein the top link and the bottom link substantially aligned along a longitudinal axis defined along a length thereof.

6. The stand assembly as recited in claim 1, wherein each of the first vertical support, the second vertical support and the common vertical support comprise a sleeve with an interior opening.

7. The stand assembly as recited in claim 6, wherein a size of the opening of the sleeve is greater than a width of the slot of a corresponding link of the plurality.

8. The stand assembly as recited in claim 6, wherein each one of the first vertical support and the second vertical support are movable along a length of the slot of corresponding links of the plurality.

9. The stand assembly as recited in claim 8, wherein the first vertical support and the second vertical support are movable towards the intersection point respectively along the length of the slot of a corresponding link of the plurality.

10. The stand assembly as recited in claim 9, wherein a movement of the first vertical support towards the intersection point reduces the effective length of the first segment; and wherein a movement of the second vertical support towards the intersection point reduces the effective length of the second segment.

11. The stand assembly as recited in claim 10, wherein a pivotal movement of the first segment and the second segment away from each other increases the distance between the first vertical support and second vertical support.

12. The stand assembly as recited in claim 1, wherein a first leg of the press is connected to a first link of the plurality above the first vertical support, a second leg of the press is connected to a second link of the plurality above the second vertical support, and a third leg of the press is connected to either the first of or the second link of the plurality above the common support.

13. The stand assembly as recited in claim 12, wherein a top link of the first group and a top link of the second group are adjacently disposed to one another in a stacked arrangement above the common vertical support; the top link of the first group and the top link of the second group being pivotally movable to one another around the intersection point.

14. The stand assembly as recited in claim 12, wherein a bottom link of the first group and a bottom link of the second group are adjacently disposed to one another in a stacked arrangement below the common vertical support; the bottom link of the first group and the bottom link of the second group being pivotally movable to one another around the intersection point.

15. The stand assembly as recited in claim 1, wherein the wheel assembly comprises a first wheel disposed below the first vertical support, a second wheel disposed below the second vertical support and a third wheel disposed below the common vertical support.

16. The stand assembly as recited in claim 15, wherein the first wheel is disposed below a bottom link of the first group, the second wheel is disposed below a bottom link of the second group and the third wheel is disposed below the bottom link of the first group and the bottom link of the second group.

17. The stand assembly as recited in claim 15, wherein the wheel assembly comprises a first bracket disposed in interconnecting relation between the first wheel and the first vertical support, a second bracket disposed in interconnecting relation between the second wheel and the second vertical support, and a third bracket disposed in interconnecting relation between the third wheel and the common vertical support.

18. A stand assembly for a press, the stand assembly comprising:
a support assembly comprising a plurality of individual links each one comprising a substantially equivalent length and width, an elongated shape and a slot disposed on a distal end thereof; the slot comprising a length that is less than the length of its corresponding one of the plurality of links,
a first pair of individual links, a first vertical support and a common vertical support collectively defining a first segment of the support assembly, the first pair of individual links comprising a top link and a bottom link disposed in spaced apart relation to one another,
a second pair of individual links, a second vertical support and the common vertical support collectively defining a second segment of the support assembly, the first pair of individual links comprising a top link and a bottom link disposed in spaced apart relation to one another,
a distal end of the first segment and a distal end of the second segment pivotally connected to one another at an intersection point thereof,
each of the first segment and the second segment comprising an effective length that is adjustable,
the first segment and the second segment pivotally movable to one another about an axis defined at the intersection point thereof, and
a wheel assembly comprising a plurality of wheels disposed below the support assembly.

19. A stand assembly for a press, the stand assembly comprising:
a support assembly comprising a top link and a bottom link comprising a substantially equivalent shape and disposed in a spaced apart relation to one another; and
a wheel assembly comprising a plurality of wheels disposed below the support assembly;
each of the top link and the bottom link of the support assembly comprising a first section and a second section with a slot disposed on a distal end thereof;
the first section of the plurality of links, a first vertical support and a common vertical support collectively defining a first segment of the support assembly; and
the second section of the plurality of links, a second vertical support and the common vertical support collectively defining a second segment of the support assembly.

20. The stand assembly as recited in claim 19, wherein a first leg and a second leg of the press are connected to the top link respectively above the first vertical support and above the second vertical support, and wherein a third leg of the press is connected to the top link at an intersection area of the first section and the second section.
